(19) United States
(12) Patent Application Publication
(10) Pub. No.: US 2004/0248518 A1
(43) Pub. Date: Dec. 9, 2004

(54) Wireless communication apparatus

(75) Inventor: Susumu Kashiwase, Kanagawa (JP)

Correspondence Address: SCHULTE ROTH & ZABEL LLP, ATTN: JOEL E. LUTZKER, 919 THIRD AVENUE, NEW YORK, NY, 10022, US

(73) Assignee: Kyocera Corporation, Kyoto-shi (JP)

(21) Appl. No.: 10/808,109

(22) Filed: Mar. 24, 2004

(30) Foreign Application Priority Data
Mar. 24, 2003 (JP) 2003-080119

(51) Int. Cl. H04B 1/06

(52) U.S. Cl. 455/63.4; 455/67.13; 455/574

(57) ABSTRACT

A wireless communication apparatus having an antenna and a control portion for controlling directivity of the antenna and communicates with a base station. The antenna is an adaptive antenna having a plurality of antenna elements and a phase shifter for changing a phase of electric power supplied to the antenna elements, and the control portion performs switching control so that directivity of the antenna is set to beam steering or null steering based on a control signal from the base station. The wireless communication apparatus properly controls the adaptive antenna by making a change in proper parameters, a change in control priority and a change in weighting.

### CROSS-REFERENCE TO RELATED APPLICATIONS

This application claims all rights of priority to Japanese Patent Application No. 2003-080119 filed on Mar. 24, 2003, (pending).

### BACKGROUND

The present invention relates to a wireless communication apparatus equipped with an adaptive antenna device having a control system in which CDMA (Code Division Multiple Access) system as a mobile communication system (cellular system) is used.

### DESCRIPTION OF THE RELATED ART

A wireless communication apparatus such as a cellular telephone establishes a communication line by means of radio waves with a wireless base station. The wireless communication apparatus communicates by transmitting and receiving sound, data, etc. through the communication line.

A mobile communication apparatus equipped with an adaptive antenna having a plurality of antenna elements for giving a directivity to the adaptive antenna is proposed. JP-A-2001-223516 is referred as a related art regarding control of the adaptive antenna. This reference recognizes three points of response to sudden propagation environment, maintenance of performance as the adaptive antenna and adoption of algorithm suitable for propagation environment. In order to overcome these points simultaneously, an object of this reference is to provide a method of together using both beam steering and null steering to compensate for disadvantages of the other.

However, in a wireless communication apparatus using a plurality of frequency bands, the amount of space attenuation of radio waves, arrangement of base stations, a multi-path state and a receiving state of radio wave which a mobile station receives are greatly different for every frequency band. Therefore, when the adaptive antenna is controlled by either the beam steering or the null steering with a single algorithm, a problem that the optimum control cannot be performed results. In addition, since a mobile station operates on a battery, it is necessary to reduce power consumption when the remaining amount of the battery becomes small. Further, when the control of the adaptive antenna in the mobile station is limited in order to level communication traffic of the network side, efficiency of lines may improve.

### BRIEF SUMMARY

An object of the present invention is to provide a wireless communication apparatus which properly controls an adaptive antenna by changing parameters, control priority and weighting.

The invention provides a wireless communication apparatus which communicates with a base station, having: an adaptive antenna; a receiving portion for receiving a control signal to control directivity of the adaptive antenna transmitted from said base station; and a control portion for controlling the directivity of the adaptive antenna utilizing beam steering or null steering based on the control signal. Therefore, proper control of directivity can be performed and rapid response to radio wave propagation environment can be made.

Furthermore, the control portion controls the directivity of the adaptive antenna by changing the weighting of the beam steering and the null steering of said adaptive antenna. Therefore, proper control of directivity can be performed and rapid response to radio wave propagation environment can be made.

Furthermore, said control portion controls the directivity of said adaptive antenna for every frequency used by the wireless communication apparatus. Therefore, proper control of directivity can be performed for every frequency.

Furthermore, the wireless communication apparatus has a receiving quality monitoring portion for monitoring quality of a signal from the base station; and a quality information transmitting portion for transmitting information about quality of a receiving signal monitored by the receiving quality monitoring portion to said base station, wherein the control portion controls the directivity of said adaptive antenna based on the control signal which the base station calculates based on the quality information. Therefore, the wireless communication apparatus (mobile stations) between adjacent base stations can be allocated properly.

Furthermore, the control portion controls the directivity of said adaptive antenna based on the control signal which said base station produces according to the number of wireless communication apparatus connected to the base station. Therefore, proper load distribution can be performed between base stations.

Furthermore, the control portion controls the directivity of the adaptive antenna based on the control signal which the base station produces according to the amount of communication in the base station. Therefore, proper load distribution can be performed between base stations.

Furthermore, the wireless communication apparatus, has a battery remaining amount detection portion for detecting a remaining amount of a battery life for the wireless communication apparatus, wherein the control portion stops the control of the directivity of the adaptive antenna based on a result of comparison between a predetermined threshold value and the remaining amount of the battery detected by the battery remaining amount detection portion. Therefore, electric power consumption is reduced and a lot of communication time can be secured.

### BRIEF DESCRIPTION OF THE DRAWINGS

FIG. 1 shows a block diagram of a configuration of a mobile station according to an embodiment of the present invention;

FIG. 2 shows a block diagram of a configuration of the mobile station of another embodiment of the invention;

FIG. 3 shows a diagram explaining an action at the time of transmitting of an adaptive antenna of the mobile station of the embodiment of an invention;

FIG. 4 shows a diagram explaining an action at the time of receiving of the adaptive antenna of the mobile station of the embodiment of the invention;

FIG. 5 shows a sequence diagram of control for changing the weighting in the mobile station of an embodiment of the invention;

FIG. 6 shows an explanatory diagram of a weighting factor of the adaptive antenna of the mobile station of the embodiment of the invention;

FIG. 7 shows a flowchart of processing for changing the weighting of the adaptive antenna in the mobile station of the embodiment of the invention;

FIG. 8 shows a sequence diagram of another control for changing weighting of the adaptive antenna in the mobile station of the embodiment of the invention; and

FIG. 9 shows a flowchart of processing for changing weighting processing of the adaptive antenna in the mobile station of the embodiment of the invention.

### DETAILED DESCRIPTION

The present invention will be described with reference to the drawings.

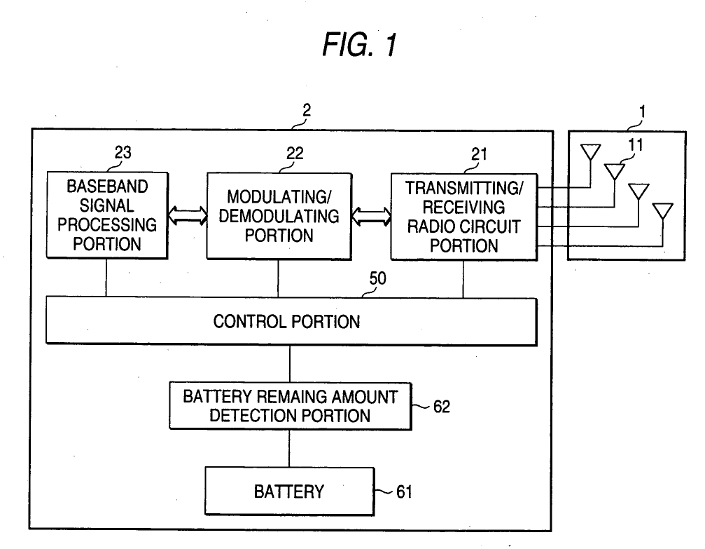

FIG. 1 is a block diagram showing a main configuration of a mobile station according to an embodiment of the invention.

A mobile station 2 has an antenna array 1 configuring an adaptive antenna.

The antenna array (adaptive antenna) 1 has a plurality of antenna elements 11. The antenna array 1 is connected to the mobile station 2 by connecting each of the antenna elements 11 to a transmitting/receiving radio circuit portion 21.

The transmitting/receiving radio circuit portion 21 includes a transmitting portion and a receiving portion. The transmitting portion produces radio wave (high frequency signals) to be transmitted from the antenna array 1 to the wireless base station 2. The receiving portion amplified or performing the frequency conversion for radio wave (high frequency signals) transmitted from the wireless base station 2 and received by the antenna array 1, and outputs a resulting signal to a modulating/demodulating portion 22.

The modulating/demodulating portion 22 has an analog-digital converter (AD converter, DA converter) and a quadrature modulator. The modulating/demodulating portion 22 relays an analog signal used by the transmitting/receiving radio circuit portion 21 and a digital signal used by a baseband signal processing part 23.

The baseband signal processing part 23 has a DSP (Digital Signal Processor). By use of the DSP, the baseband signal processing part 23 performs coding, decoding, compression and decompression of an coded signal, and error correction of a received signal.

The mobile station 2 further has a control portion 50, an operation portion (not shown), a display portion (not shown), a microphone (not shown), a speaker (not shown), etc. The control portion 50 is mainly configured by a CPU. The control portion 50 controls respective portions of the mobile station 2 based on data stored in memory. Further, the mobile station 2 has a battery 61 to be a power of the mobile station 2 and a battery remaining amount detection portion 62 which detects the remaining amount of the battery 61.

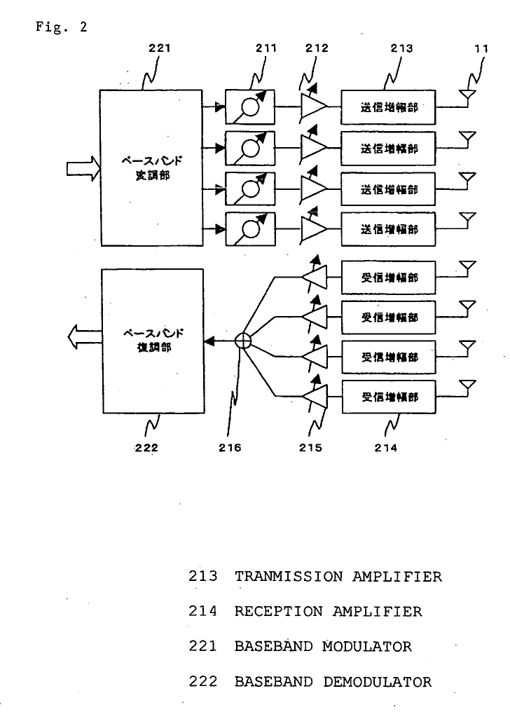

FIG. 2 is a block diagram showing a detailed configuration of the transmitting/receiving radio circuit portion 21 and its periphery in the mobile station 2 according to the embodiment of the invention.

An amplifier which enables to vary an amplification factor and a phase shifter which enables to vary the amount of phase shift are connected to each antenna element 11. The directivity of the antenna array 1 is changed in accordance with variation in characteristics of the amplifier and the phase shifter.

Specifically, high frequency signals which is output from a baseband modulator 221 are input to phase shifters 211 provided in parallel. Each phase shifter 211 is configured so that the control portion 50 controls the phase shifter 211 to vary the phase of a signal input to the phase shifter 211. The high frequency signals input to the phase shifters 211 are shifted to have different phases from one phase shifter to another. The high frequency signal whose phase is different from one phase shifter to another is input to an amplifier 212 corresponding to a phase shifters 211. Each amplifier 212 is configured so that the control portion 50 as to controls the amplifier 212 to vary the amplification factor. The high frequency signals input to the amplifier 212 are amplified to have different amplitude factors from one amplifier to another. The high frequency signal output from the amplifiers 212 is input to the transmission amplifier 213 corresponding to a amplifier 212. The high frequency signal input to the transmission amplifier 213 is then amplified to have power required for transmission to a base station.

That is, the phase shifters 211, the amplifier 212 and the transmission amplifier 213 are respectively provided for each of the antenna elements 11 and decide the phase and power of the high frequency signal to be provided to each antenna element 11. The phase shifters 211 and the amplifiers 212 are controlled by the control portion 50. The control portion 50 controls the directivity of the antenna array 1 by controlling the phase and the power of the high frequency signal to be input to each antenna element 11.

A pair of the amplifier 212 and the phase shifter 211 is provided for a beam steering control algorithm which strengthen directivity of a direction of the base station in communication at present. Another pair of the amplifier 212 and the phase shifter 211 is provided for a null steering control algorithm which weaken directivity of a direction of a base station in the vicinity of the base station in communication at present.

Signals which are transmitted from a base station and received by the antenna elements 11 are input to reception amplifiers 214 provided correspondingly to the antenna elements 11. The reception amplifier 214 amplifies the signals to have strengths required for processing the signals in each portion of the mobile station 2. The amplified high frequency signals are input to amplifiers 215 provided correspondingly to the reception amplifiers 214. Each amplifier 215 is configured so that the control portion 50 controls the amplifier 215 to vary its amplification factor. The high frequency signals input to the amplifiers 215 are amplified to have different amplitude factor from one amplifier to another. The amplified high frequency signals are then synthesized by a mixer 216 and input to a baseband demodulator 222.

A pair of the amplifiers 215 is provided for the beam steering control algorithm. Another pair of the amplifier 215 is provided for the null steering control.

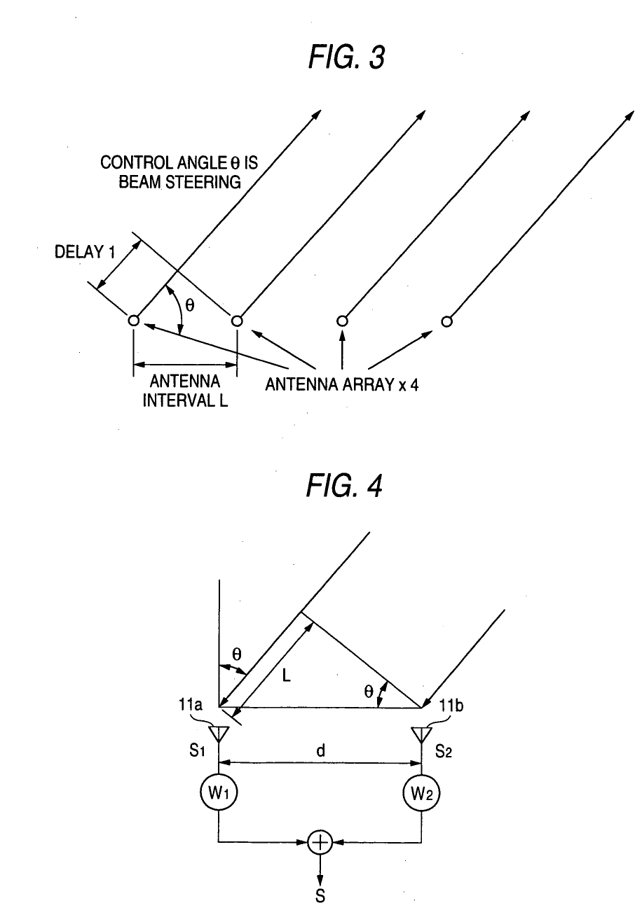

FIGS. 3 and 4 are diagrams for explaining the operation of the adaptive antenna of the mobile station according to the embodiment of the invention.

Control of directivity of the antenna array 1 at the time of transmission is shown in FIG. 3. In beam steering in which the radio wave is intensively radiated in a certain direction, a delay of a high frequency signal supplied to each antenna element 11 (phase difference: Delay1) is represented by the following equation.

Delay1=N×λ=Lcosθ

where θ is an angle between a reference direction (direction of a row of the arrayed antenna elements) and a desired direction.

That is, when a phase difference of a transmission signal supplied to each antenna element 11 is controlled to satisfy the equation, the radio wave is intensively transmitted in the direction of θ.

On the other hand, in null steering in which radio wave radiated in a certain direction is weakened, a delay of a high frequency signal supplied to each antenna element 11 (phase difference: Delay1) is represented by the following equation.

Delay1=(2×N+1)×λ/2=Lcosθ

where θ is an angle between a reference direction (direction of a row of the arrayed antenna elements) and a desired direction.

That is, when a phase difference of a transmitted signal supplied to each antenna element 11 is controlled to satisfy the equation, radio wave transmitted in the direction of θ can be weakened.

Here, N is a number showing order of the antenna elements 11, and λ is a wavelength of a transmitting wave, and L is an arrangement distance between the antenna elements 11.

Control of directivity of the antenna array 1 at the time of reception is shown in FIG. 4.

When it is assumed that an incoming direction of radio waves is θ, a receiving signal S1 of an antenna element 1 la and a receiving signal S2 of an antenna element 11b are expressed by the following equations.

S₁=cos(ωt)

$${S}_{2} = cos ( ω t + 2 π \frac{d}{λ} sin θ )$$

A signal S combined by the mixer 216 is expressed by the following equation in which the receiving signals S1, S2 of each the antenna element are multiplied by weighting factors W1, W2 and then the obtained receiving signals of both antenna elements are combined.

$$S = {w}_{1} cos ( ω t ) + {w}_{2} cos ( ω t + 2 π \frac{d}{λ} sin θ )$$

When the receiving signals S1, S2 of each antenna element are represented by complex numbers, the combined receiving signal S can be expressed by a function of W1, W2 and θ as follows.

$$S = A ( t ) {ⅇ}^{- j ( ω t + ϕ ( t ) ]} ( {w}_{1} + {w}_{2} {ⅇ}^{- j ( 2 π \frac{d}{λ} sin θ )} )$$

When the weighting factors W1, W2 are adjusted so that a value of the combined receiving signal S is maximized in a desired direction (θ), the directivity of the antenna can be set to the beam steering. On the other hand, when the weighting factors W1, W2 are adjusted so that the value of the combined receiving signal S is minimized in a desired direction (θ), the directivity of the antenna can be set to the null steering.

When the number of antenna elements is large, characteristics of the antenna can be expressed by the following equation.

$$S = A ( t ) {ⅇ}^{- j [ ω t + ϕ ( t ) ]} ( {w}_{1} + {w}_{2} {ⅇ}^{- j ( 2 π \frac{d}{λ} sin θ )} + … + {w}_{n} {ⅇ}^{- j ( 2 π \frac{nd}{λ} sin θ )} )$$

In this case, the combined receiving signal S can be expressed by a function of W1, . . . Wn and θ. That is, receiving directivity is controlled by changing weighting of signals with different phases coming to each antenna element.

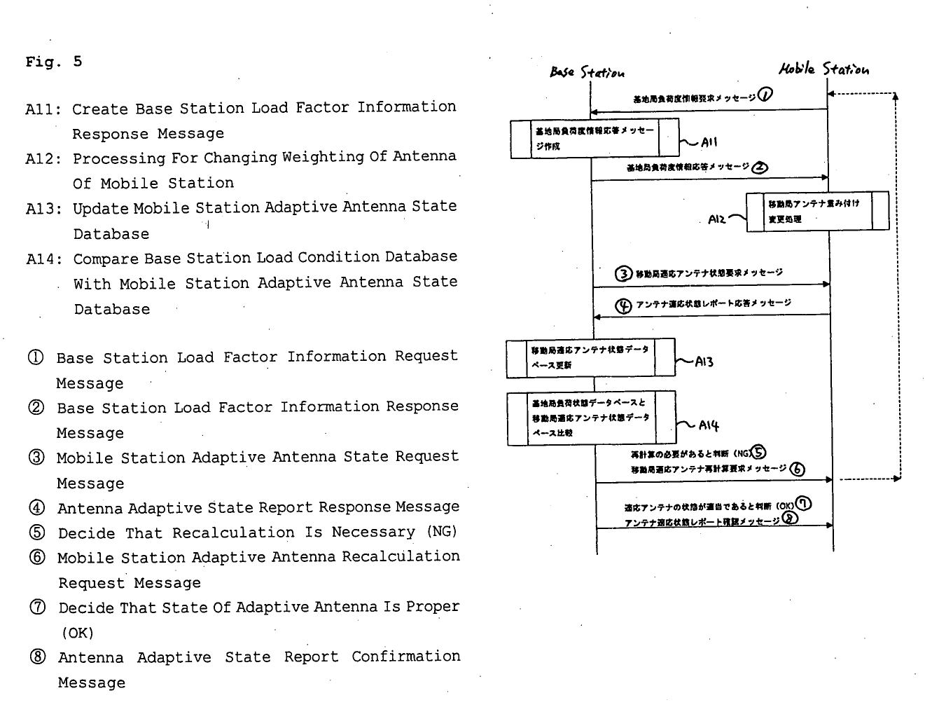

FIG. 5 is a sequence diagram of control for changing weighting of the antenna array 1 in the mobile station 2 of the embodiment of the invention.

Control shown in FIG. 5 shows an example of a control sequence which changes weighting of beam steering and null steering in response to a message from a base station.

The mobile station 2 transmits a base station “a base station load factor information request message” which requires information about a degree of margin for load on a network. Then, the base station produces “a base station load factor information response message” which shows a degree of margin for load on the network based on a notification message or a control message (step A11). Subsequently, the base station transmits the mobile station the base station load factor information response message. The number of mobile stations communicating with the base station, a use rate (occupancy slot rate) of a frequency resource of the base station, a load factor of a network, a degree of margin to a congestion state, etc. are used in order to produce base station load factor information. The base station load factor information response message includes information about a degree of margin for a load of adjacent base stations in addition to information about a degree of margin for a load of the base station communicating at present.

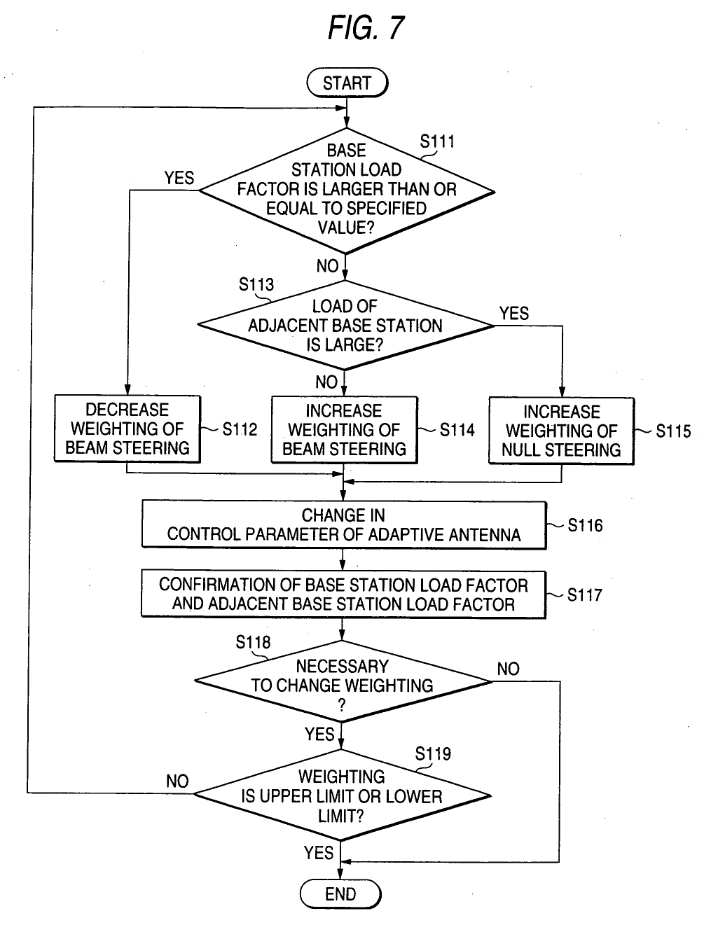

Next, the mobile station 2 changes weighting of a signal from the antenna element 11 according to the cases with and without a degree of margin for a network on the basis of the base station load factor information response message received (step A12). That is, the mobile station 2 changes weighting of the beam steering and the null steering in the antenna array 1. Thus, according to which is regarded as important, either the beam steering or the null steering, characteristics of the antenna array 1 are changed (see FIG. 7).

On the other hand, in the case of grasping a state of the mobile station 2 in the network side, the base station transmits a mobile station adaptive antenna state request message to the mobile station 2. In response to the mobile station adaptive antenna state request message, the mobile station 2 transmits an antenna adaptive state report response message showing control states of the antenna array 1, which includes a state of beam steering control, a state of null steering control and weighting factors of the beam steering and the null steering.

The base station which has received the antenna adaptive state report response message updates “a mobile station adaptive antenna state database” in which a control state of the antenna array 1 is stored every mobile station (step A13).

Then, the base station refers to the mobile station adaptive antenna state database and a base station load condition database in which a load condition of the base station is stored to compare these databases (step A14). When the base station judges that a state of the antenna array 1 of the mobile station 2 is improper and it is necessary to recalculate control parameters of the antenna array 1, the base station transmits “a mobile station adaptive antenna recalculation request message” to the mobile station 2. The mobile station 2 which has received the mobile station adaptive antenna recalculation request message transmits “a base station load factor information request message” to the base station, and performs a processing for changing weighting of the antenna array 1 of the mobile station 2 based on a base station load factor information response message returned from the base station.

On the other hand, when the base station judges that a state of the antenna array 1 is proper and it is unnecessary to recalculate the control parameters of the antenna array 1, the base station transmits “an antenna adaptive state report confirmation message” to the mobile station 2.

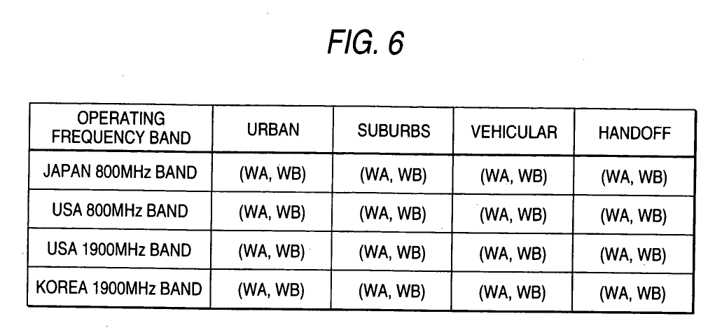

FIG. 6 shows an example of a weighting factor of the antenna array 1 of the mobile station 2 according to the embodiment of the invention.

When it is assumed that a receiving signal of a system A for performing a beam steering process is RA, a weighting factor is WA, a receiving signal of a system B for performing a null steering process is RB and a weighting factor is WB, an output from the antenna array 1 in which outputs from all the antenna elements are combined is expressed by the following equation.

Rtotal=RA×WA+RB×WB

The values best suitable for the WA, WB are determined by field experiment or simulation and are stored every frequency band, every present environment of the mobile station. For example, as compared WA, WB of a 800 MHz band with those of a 1900 MHz band, the value of WA is set relatively larger than the value of WB in the 1900 MHz band in which loss of space transmission is large so as to give directivity in a beam steering manner to the antenna array 1. On the other hand, the value of WB is set relatively larger than the value of WA in the 800 MHz band in which the loss of space transmission is small so as to give directivity in a null steering manner to the antenna array 1. Also, in the case that the mobile station 2 receives a signal from a single base station using information from a demodulator of the mobile station 2 or the case that the number of base stations of a handoff candidate is small, WA is set somewhat large so as to give directivity in a beam steering manner to the antenna array 1. On the other hand, in the case that the mobile station 2 receives a signal from a plurality of base stations or the case that the number of base stations of a handoff candidate is large, WB is set somewhat large so as to give directivity in a null steering manner to the antenna array 1. In the case of being in high-speed data communication, WB may be set somewhat large in order to reduce an interference wave level.

The RA, RB, WA and WB may be scalar quantity or vector quantity.

FIG. 7 is a flowchart of processing for changing a control parameter (weighting) of the antenna array 1 of the mobile station 2 according to the embodiment of the invention, which is executed in the step for a change in weighting of the adaptive antenna in the sequence diagram (step A12 in FIG. 5) described above.

First, a network load of a base station is compared with a predetermined threshold value on the basis of the base station load factor information response message which the mobile station 2 has received (S111).

When the load is larger than or equal to a predetermined specified value, weighting of the beam steering is decreased because the load of the base station is large (S112). That is, when there is no margin for the network load, both the beam steering and null steering are not performed to prevent the network load from increasing carelessly.

On the other hand, when this load is smaller than the predetermined specified value, the load of the base station is small. In this case, the mobile station 2 judges whether or not a load of an adjacent base station is large (S113). Then, when the load of the adjacent base station is smaller than a predetermined specified value, the load of the adjacent base station is also small, so that weighting of the beam steering is increased (S114).

On the other hand, when the load of this adjacent base station is larger than or equal to the predetermined specified value, the load of the base station is large. In this case, weighting of the null steering is increased (S115). Further, a signal level transmitted to an adjacent base station is decreased. Thus, since tendency to cause a handoff is reduced, an increase in a load of the adjacent base station with a large load is suppressed.

When calculation of the weighting of the antenna array 11 (S112, S114, S115) is completed, the control parameter of the antenna array 11 is changed according to the weighting calculated (S116). Then, load factors of the adjacent base station and the base station in connection at present are confirmed (S117) and it is determined whether or not it is necessary to change the weighting (S118).

Thereafter, it is determined whether beam steering or null steering is 100% with reference to whether weighting is an upper limit or a lower limit (S119). Then, when the weighting is the upper limit or the lower limit, the process is ended. When the weighting is neither the upper limit nor the lower limit, the flowchart returns to the start of this process and the control parameter of the antenna array 11 is calculated again.

As described above, the weighting of the beam steering and the null steering is changed to vary a directivity of the antenna array 1 in consideration of the load factors of the adjacent base station and the base station in communication at present. Therefore, quality of a line of communication with the base station is improved so that a higher data rate can be achieved.

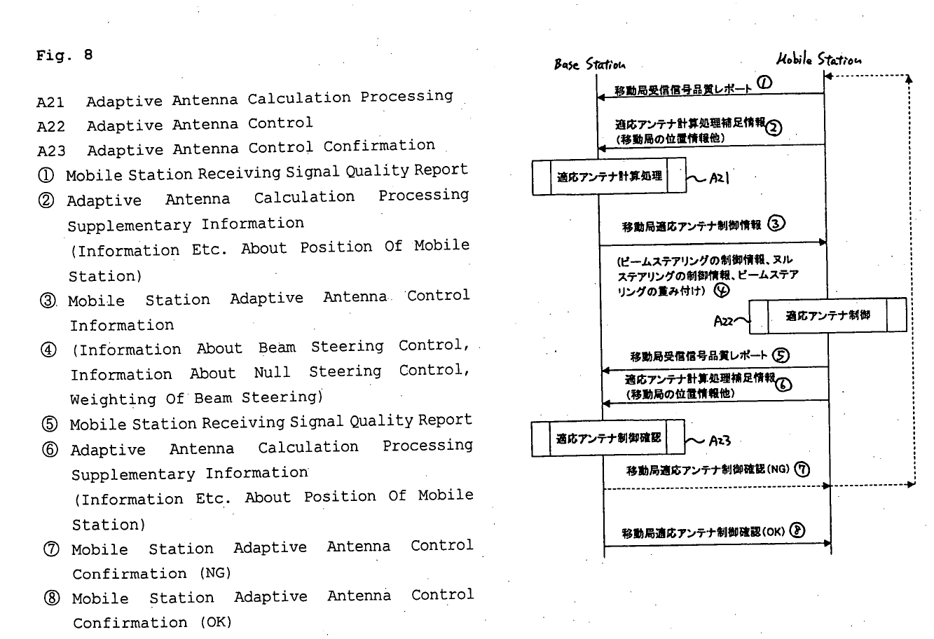

FIG. 8 is a sequence diagram of another control for changing weighting of the antenna array 1 in the mobile station 2 of the embodiment of the invention.

The mobile station 2 reports signal strength of each radio wave incoming direction of one or more base stations from which the mobile station 2 can receive as “a base station signal quality report” to a base station. Then, the mobile station 2 transmits information etc. about a position of the mobile station 2 to the base station as “adaptive antenna calculation processing supplementary information”. Based on the base station signal quality report and the adaptive antenna calculation processing supplementary information from the mobile station 2, an adaptive antenna calculation portion in an apparatus provided on a network side calculates the weighting of the beam steering and the null steering (step A21). Then, the base station reports its result to the mobile station as “mobile station adaptive antenna control information”. The mobile station adaptive antenna control information includes control information about the beam steering, control information about the null steering, and information about weighting of the beam steering and the null steering.

Then, based on the reported mobile station adaptive antenna control information, the mobile station 2 performs an adaptive antenna control process by setting a control parameter of the antenna array 1 (step A22). Then, the mobile station 2 reports signal strength of each radio wave incoming direction of one or more base stations from which the mobile station 2 can receive as “a base station signal quality report”, and transmits information etc. about a position of the mobile station 2 to the base station as “adaptive antenna calculation processing supplementary information”. Based on the signal strength of the base station received by the mobile station 2, the adaptive antenna calculation portion in the apparatus provided on the network side calculates the weighting of the beam steering and the null steering (step A23). It is confirmed whether or not a control state of the antenna array 1 is proper on the network side based on the base station signal quality report and the adaptive antenna calculation processing supplementary information from the mobile station 2.

As a result, when it is determined that the control state of the antenna array 1 is improper, a mobile station adaptive antenna control confirmation signal (NG) is transmitted and a control parameter of the antenna array 1 is calculated and adaptive antenna control processing is performed.

On the other hand, when it is determined that the control state of the antenna array 1 is proper, a mobile station adaptive antenna control confirmation signal (OK) is transmitted.

As described above, the control parameter of the antenna array 1 is calculated by the adaptive antenna calculation portion of the base station, and characteristics of the antenna array 1 are calculated. Therefore, since adaptive antenna control of the mobile station 2 can be performed integrally on the network side, allocation of mobile stations between adjacent base stations, making a network load uniform, avoidance of congestion of mobile stations requiring high-speed data communication, etc. can be achieved.

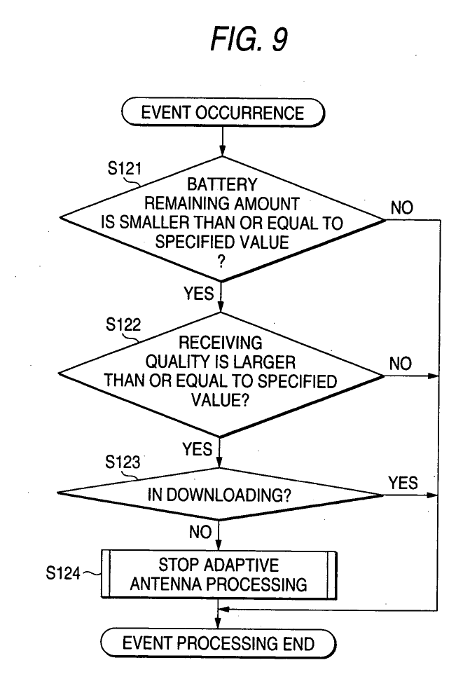

FIG. 9 is a flowchart of processing for changing weighting process of the antenna array 1 in the case that the remaining amount of a battery reduces in the mobile station 2 according to the embodiment of the invention.

Control of the antenna array 1 requires more high frequency circuits and calculation processing as compared with the case that control of the antenna array 1 is not performed. Even in the case of performing the control of the antenna array 1 in the mobile station 2 operating on a battery, it is necessary to reduce electric power consumption. Particularly, its necessity is large in a small remaining amount state in which a voltage of the battery reduces.

First, it is determined whether or not the remaining amount of a battery is smaller than or equal to a predetermined specified value (S121). The battery remaining amount is obtained by measuring a battery voltage or summing consumption currents.

When the remaining amount of the battery is smaller than or equal to the predetermined specified value, it is determined whether or not receiving quality is larger than or equal to a predetermined specified value (S122). When the receiving quality is larger than or equal to the predetermined specified value, it is decided that there is a small necessity for the adaptive antenna process for acquiring good receiving quality, and further it is determined whether or not data is downloaded (S123). When data is not downloaded, it is decided that an influence on communication is small even if directivity of the antenna array 1 is changed, and the adaptive antenna process is stopped (S124).

However, when the adaptive antenna process is stopped, quality of a receiving signal degrades. Therefore, it could be configured so as not to stop the adaptive antenna process in data communication at high communication speed.

In the process shown in FIG. 9 thus, in the case that the remaining amount of the battery is small, the adaptive antenna process is not performed and electric power consumption is reduced and a lot of communication time can be secured.

What is claimed is:

1. A wireless communication apparatus, that communicates with a base station, comprising:
an adaptive antenna;
a receiving portion for receiving a control signal, to control directivity of said adaptive antenna, transmitted from said base station; and
a control portion for controlling the directivity of said adaptive antenna to be a beam steering or a null steering based on the control signal.

2. The wireless communication apparatus according to claim 1,
wherein said control portion controls the directivity of said adaptive antenna by changing weighting of the beam steering and the null steering of said adaptive antenna.

3. The wireless communication apparatus according to claim 1,
wherein said control portion controls the directivity of said adaptive antenna every frequency used by said wireless communication apparatus.

4. The wireless communication apparatus according to claim 1, further comprising:
a receiving quality monitoring portion for monitoring quality of a signal from said base station; and
a quality information transmitting portion for transmitting information about quality of a receiving signal monitored by said receiving quality monitoring portion to said base station,
wherein said control portion controls the directivity of said adaptive antenna based on the control signal which said base station calculates based on the quality information.

5. The wireless communication apparatus according to claim 1,
wherein said control portion controls the directivity of said adaptive antenna based on the control signal which said base station produces according to the number of wireless communication apparatuses connected to said base station.

6. The wireless communication apparatus according to claim 1,
wherein said control portion controls the directivity of said adaptive antenna based on the control signal which said base station produces according to the amount of communication in said base station.

7. The wireless communication apparatus according to claim 1, comprising:
a battery remaining amount detection portion for detecting a remaining amount of a battery powering said wireless communication apparatus,
wherein said control portion stops the control of the directivity of said adaptive antenna based on a result of comparison between a predetermined threshold value and the remaining amount of said battery detected by said battery remaining amount detection portion.
